(19) United States
(12) Patent Application Publication
(10) Pub. No.: US 2014/0292894 A1
(43) Pub. Date: Oct. 2, 2014

(54) INSULATING SUBSTRATE ELECTROSTATIC INK JET PRINT HEAD

(71) Applicant: XEROX CORPORATION, Norwalk, CT (US)

(72) Inventor: DAVID L. KNIERIM, WILSONVILLE, OR (US)

(73) Assignee: XEROX CORPORATION, Norwalk, CT (US)

(21) Appl. No.: 13/853,654

(22) Filed: Mar. 29, 2013

(51) Int. Cl. B41J 2/16; B41J 2/14

(52) U.S. Cl. CPC B41J 2/1623; B41J 2/14
USPC 347/20; 438/21

(57) ABSTRACT

A print head has a insulating substrate, a conductive layer on the insulating substrate, the conductive layer including interconnect patterns and actuation pads corresponding to each of an array of jets, an insulating layer on the conductive layer, a membrane attached to the insulating layer, and a jet stack attached to the membrane.

### BACKGROUND

Some ink jet print heads, including solid ink jet print heads, use a piezoelectric ceramic material typically consisting of lead zirconium titanate, abbreviated PZT, that converts electric signals to mechanical motion. The PZT elements move in response to the signals, acting on a membrane that flexes to eject ink onto a print substrate. The ink resides in chambers adjacent the PZT elements and membrane, the chambers formed from a stack of plates referred to as a jet stack.

Custom integrated circuits (ASICs) provide the electrical drive signals to the PZT elements. The ASICs typically reside in ball-grid array (BGA) packages soldered to electronic circuit boards. The electronic circuit boards connect to the PZT elements through a flexible (flex) circuit. Developments have led to the ASIC dies bonding directly to the flex circuits, a process referred to as chip-on-flex (COF). Chip-on-flex is employed widely in flat panel displays, but displays are moving towards chip-on-glass, which is cheaper and achieves higher interconnect density.

Development continues on other technologies related to the ink jet print heads. One promising area lies in MicroElectrical Mechanical Systems (MEMS). MEMS based print heads typically use electrostatic actuation instead of PZTs. These print heads use about 80% less electrical energy to eject an ink drop compared to PZTs, but the cost of manufacture is higher because of expensive IC processing and substrates used in typical MEMS processes.

It would be beneficial to be able to combine the lower costs of chip-on-glass with the efficiencies of MEMS technologies to produce a low-cost, efficient print head.

### BRIEF DESCRIPTION OF THE DRAWINGS

FIG. 1 shows a cross sectional diagram of an internal configuration of an ink delivery system and a single ink jet.

FIG. 2 shows a cross section diagram of an internal configuration of an embodiment of a insulating substrate print head and ink delivery system and a single jet.

FIGS. 2-6 show a process of manufacturing a insulating substrate print head.

FIGS. 7-8 show a portion of a membrane in a insulating substrate print head in a partially deflected state and a more fully deflected state.

### DETAILED DESCRIPTION OF THE EMBODIMENTS

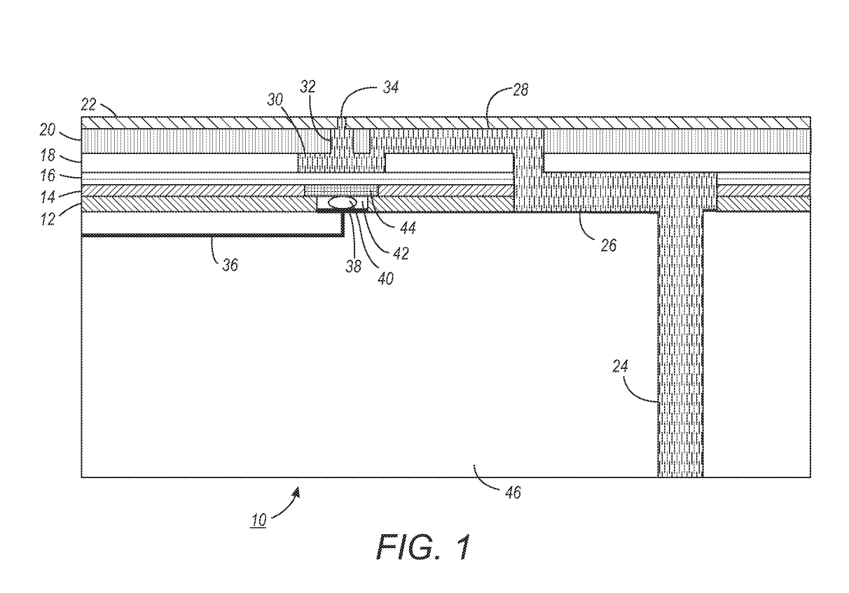

FIG. 1 shows a cross section of the internal components of an ink delivery system and inkjet stack 10, as shown in U.S. Pat. No. 8,226,207. The stack includes a standoff layer 12 that leaves an air gap 42 located immediately below a piezoelectric transducer 44, which bends when an electric current is transmitted down transducer driver 36 to a metallic film 38. A flexible electrically conductive connector 40 connects the metallic film with the transducer allowing electric current to flow to the piezoelectric transducer. The flexible connector may be an electrically conductive adhesive such as silver epoxy that maintains the electrical connection with the piezoelectric transducer when the piezoelectric transducer bends either towards or away from the metallic film. The piezoelectric transducer is surrounded by a spacer layer 14 that supports the vertical stack. In the embodiment of FIG. 1, the standoff layer and spacer layer are each between 25 micrometers (um) and 50 um in thickness, and the piezoelectric transducer is between 25 um and 75 um in thickness.

The piezoelectric transducer is attached to a flexible diaphragm 16 located immediately above the piezoelectric transducer. The electric current driving the piezoelectric transducer either bends the transducer towards the diaphragm or bends the transducer away from the diaphragm towards the air gap. The diaphragm responds to the bending of the piezoelectric transducer, and returns to its original shape once the electric signal to the piezoelectric transducer ceases. The diaphragm in this embodiment may be selected to be in the range of 10-40 um in thickness.

The body layer 18 lies above the diaphragm, the body layer having lateral walls forming a pressure chamber 30. The diaphragm resides immediately below the pressure chamber forming one of its walls. In this embodiment, the body layer and pressure chamber are either 38 um or 50 um thick. The pressure chamber has four lateral walls that may optionally be approximately the same length forming a rhombus or square shaped area. In this embodiment each wall may range from 500 um to 800 um in length, defining the length and width dimensions of the inkjet stack.

Above the body layer, the aperture brace layer 20 forms lateral walls around the outlet 32 that fluidly connects to the pressure chamber. In this embodiment, the aperture brace layer and outlet are 50 um thick. The combined volumes of the pressure chamber and the outlet should not exceed 0.025 mm³. At the base, the aperture plate 22 surrounds the narrower ink aperture 34. The aperture fluidly connects to the outlet. The aperture plate is 25 um thick in this embodiment. While FIG. 1 depicts an inkjet stack in an orientation with the aperture at the top of the figure, this is only one of many possible orientations including having the inkjet stack oriented in the opposite direction vertically, oriented horizontally, or at an arbitrary angle.

Continuing to refer to FIG. 1, ink travels from the port 24 to the manifold 26. The inkjet stack fluidly connects to the manifold by an inlet channel 28, formed in an inlet layer. The inlet channel connects the manifold and the ejector of the inkjet stack to enable ink to flow from the manifold and enter the pressure chamber.

When the piezoelectric transducer bends in response to an electric current, the diaphragm deflects, urging the ink out of the pressure chamber into the outlet and aperture. The ink flows from the broader pressure chamber outlet to the narrower aperture where an ink droplet forms and is expelled from the inkjet stack. The piezoelectric transducer may then bend in the opposite direction, pulling the diaphragm away from the pressure chamber to pull ink from the inlet channel into the pressure chamber after a droplet is ejected.

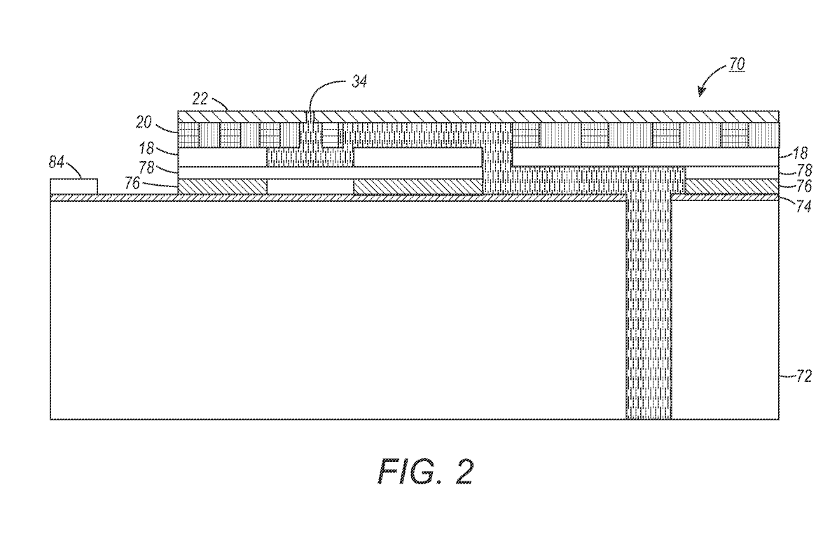

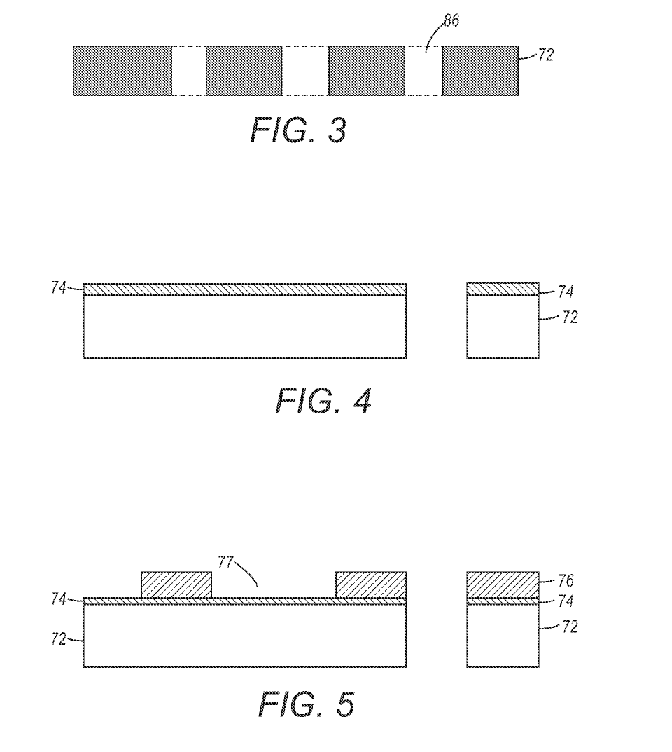

FIG. 2 shows an embodiment of an insulating substrate print head 70. The insulating substrate 72 has formed upon it a conductive layer 74. The insulating substrate may be glass, silicon or any other type of insulating material usable as a substrate. It should be noted that this discussion may mention chip-on-glass processes, and one should understand that those processes may apply to any insulating substrate, even those not glass. The conductive layer 74 includes the interconnect paths that direct drive signals to electrostatic actuation pads that will actuate portions of the membrane to cause it to eject ink onto a print substrate. An insulator 76 is deposited on the conductive layer 74. The insulator layer may consist of an insulator that is also a glue or adhesive layer, such as a partially-cured photoresist. Alternately, the insulator and/or adhesive layer may consist of silicon dioxide or nitride, which is coated with a thin layer of silver for silver diffusion bonding, discussed in more detail later. Another embodiment uses the material SUB, manufactured by MicroChem, is an epoxy-based negative photoresist is an example of such a material.

A membrane 78 is pressed down onto the insulator layer. Body spacers 18 are then formed on the membrane. The aperture brace 20 is then bonded to the insulating substrate/membrane structure via the body spacers or an additional adhesive. The aperture plate 22 with the nozzles such as 34 from FIG. 1 is attached to the aperture brace such as in FIG. 1, either prior to or after bonding aperture brace 20 to the insulating substrate/membrane structure.

Comparing FIG. 2 to FIG. 1, the insulating substrate 72 of FIG. 3 corresponds to the thick layer 46 in FIG. 1. The conductive layer 74 corresponds to the standoff layer 12. The insulator adhesive layer 76 corresponds to the spacer layer 14, where, if PZT transducers were used, they would reside in the gaps 77 (Can gap 77 be changed to white fill to properly represent a gap? Other areas could be changed to different shadings as needed. This applies to gap 77 in all figures.) of the layer 76 adjacent the membrane 78. The membrane 78 corresponds to the membrane 16 of FIG. 1. The body spacers 18 of FIG. 2 correspond to the body layer 18 of FIG. 1, with the rest of the jet stack of FIG. 1 corresponding to the remaining portions of FIG. 2.

The print head of FIG. 2 consists of a direct marking, ink jet print head. Ink is provided to the print head through the insulating substrate to the jet stack. In some instances, the ink jet will use solid ink. The ink comprises polymer solids in black and any colors that are melted away from the print head and transported to the print head through typically heated umbilicals. The ink then travels to the jet stack to reach chambers adjacent the membrane. When the membrane is electrostatically actuated, ink is ejected through aperture 34 onto a print substrate. The electrostatic actuation pads formed in the conductive layer correspond to the jets in the array of jets.

FIGS. 3-6 show a method of manufacturing a print head. The process starts as shown in FIG. 3 by providing a insulating substrate 72 having ink ports 86. The ink ports will not be shown in further figures for simplicity. The ink ports may be etched, ultrasonically machined, or drilled into the insulating substrate. The insulating substrate links to a source of ink remote from the print head.

FIG. 4 shows a conductive layer 74 formed on the insulating substrate 72. The conductive layer 74 may consist of metal or a mix of materials including conductive materials. The conductive layer may be evaporated or otherwise deposited on the substrate and then etched to from the interconnect paths to route the drive signals and the electrostatic actuation pads for each jet in the array of jets.

FIG. 5 shows an insulator layer 76 formed on the conductive layer 74. The insulator layer may consist of an insulator and/or an adhesive layer. The layer will typically only be deposited on select portions of the metal layer to allow for gaps under the membrane that will allow the membrane to move. In one embodiment, the adhesive layer uses silver diffusion bonding. An SiO₂ insulating layer is deposited onto the insulating substrate/conductive layer structure and then coated with a thin layer of silver as the layer 76. The underside of the diaphragm 78, the addition of which is shown in FIG. 6, is also coated with a silver coating 79. When the diaphragm is pressed onto the insulator layer, the diaphragm and the insulator layer are diffusion bonded at approximately 250° C. An air gap 77 is formed in the insulator that will allow the membrane to have freedom of movement.

In a particular embodiment, the layer 76 consists of SiO₂ and is 0.9 um thick and coated with 0.1 um of silver. The diaphragm is coated with 0.1 um of silver as 79, resulting in a total adhesive layer thickness of 1.1 um. In another embodiment, the insulator/glue layer may consist of a 1 um thick layer of SUB. The insulator/glue layer may be selectively deposited or etched to leave gaps for the membrane to move. The diaphragm 78 may consist of one of many different materials, but will typically be a thin metal layer such as titanium, for example. The diaphragm layer may be metal foil between 10 um and 20 um thick.

FIG. 6 shows the addition of the application-specific integrated circuit 84. The ASIC lies on the interconnect paths to direct the drive signals to the electrostatic actuators as needed. The ASIC is attached using standard chip-on-glass technology, directly to the interconnect paths. At this point, the manufacturing process will mimic that of the manufacturing process used to develop the print head of FIG. 1. Referring back to FIG. 2, after the membrane is attached to the insulator 76, body spacers 18 are then attached to the membrane, followed by the aperture brace 20 and the aperture plate 22. These portions of print head may be referred to as the jet stack.

Typically, the attachment process involves a bonding press. The bonding may involve using a bonding press to press the jet stack to the substrate/diaphragm layer. Typically, the jet stack will be formed in a separate, concurrent process and then the two substructures are bonded. The resulting print head may use the same ASIC technology as PZT architectures, but at much lower currents. The overall result is a print head that costs less to manufacture and uses less energy.

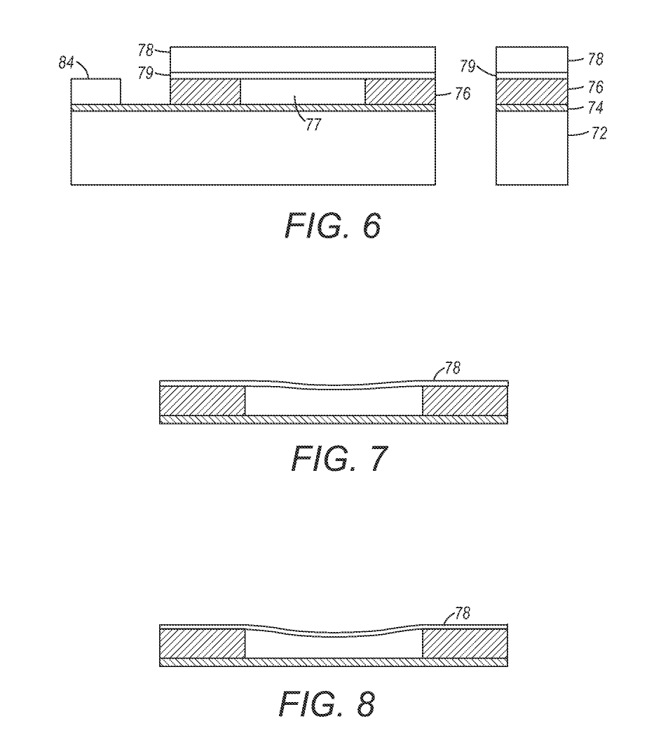

During operation, the membrane 78 is held partially deflected as shown in FIG. 7 In one embodiment, the peak deflection at the center should be 15% of the gap height. Because the membrane can only deflect in one direction, manipulation of the deflected states is used to perform the pull in of the ink and then the push out. During operation, membrane portions correspond to the jets of the print head are held in the partially deflected state as their default position. When the ink is to be pulled into the reservoir, the membrane is deflected even further. The membrane is then released to push the ink out of the nozzle 34. In one embodiment, the partially deflected state holds the membrane down at 150 nanometers (nm), and the fully deflected state pulls it down to around 250 nm. The ‘undeflected’ state is approximately deflected 50 nm down.

Being able to mimic the previous style PZT-based print heads with two active states, one deflected above the default state, and the other deflected below the default state, allows use of all of the previously developed driving waveforms that manage ink resonance, etc. This includes the ability to adjust the deflection amplitude on a jet-by-jet basis to compensate for natural manufacturing variations in jet performance, a process referred to as “normalization”. One should note that other microelectromechanical systems (MEMS) approaches typically ‘land’ the membrane, bringing it all the way down into contact with insulating spacers constructed onto the substrate and/or diaphragm. This type of approach cannot utilize these waveforms. In addition, many of these approaches use silicon based membranes, which are typically very expensive.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A print head, comprising:
a insulating substrate;
a conductive layer on the insulating substrate, the conductive layer including interconnect patterns and actuation pads corresponding to each of an array of jets;
a drive circuit attached to the insulating substrate, electrically connected to the actuation pads;
an insulating layer on the conductive layer, the insulating layer having gaps;
a membrane attached to the insulating layer and in contact with the array of transducers; and
a jet stack attached to the membrane.

2. The print head of claim 1, wherein the insulating substrate comprises a insulating substrate having ink ports.

3. The print head of claim 1, wherein the insulating substrate is coupled to an ink source through the ink ports.

4. The print head of claim 1, wherein the insulating substrate comprises one of glass or silicon.

5. The print head of claim 1, wherein the conductive layer comprises metal formed into the interconnect patterns and actuation pads.

6. The print head of claim 1, wherein the insulating layer comprises a insulating and glue layer.

7. The print head of claim 6, wherein the insulating layer comprises photoresist.

8. The print head of claim 1, wherein the membrane comprises one of stainless steel, titanium, and nickel.

9. The print head of claim 1, wherein the membrane comprises a membrane having partially etched areas.

10. The print head of claim 1 further comprising a body spacer between the membrane and the jet stack.

11. A method of manufacturing a print head, comprising:
providing a insulating substrate;
forming conductive interconnect paths and pads on the insulating substrate;
depositing an insulator layer on at least a portion of the interconnect paths and pads;
pressing a membrane onto the insulator layers;
attaching an application-specific integrated circuit to the interconnect paths; and
bonding a jet stack to the membrane.

12. The method of claim 11, wherein providing a insulating substrate having ink ports.

13. The method of claim 12, further comprising forming the ink ports comprising one of drilling or etching or ultrasonically machining the ports.

14. The method of claim 11, wherein forming the conductive interconnect paths and pads comprises depositing a metal onto the insulating and etching the metal to form the interconnect paths and pads.

15. The method of claim 14, wherein depositing the metal comprising evaporating the metal onto the insulating.

16. The method of claim 11, wherein depositing an insulator layer on the interconnect paths and pads comprises depositing a photoresist onto the interconnect paths and pads.

17. The method of claim 11, wherein depositing an insulator layer comprises:
depositing an insulator;
coating the insulator with a metal;
coating an underside of the membrane with a metal; and
bonding the insulator with the membrane by heating.

18. The method of claim 11, wherein bonding the jet stack comprises forming a jet stack out of several of metal and polymer layers prior to bonding the jet stack to the membrane.

19. The method of claim 18, wherein bonding the jet stack comprises using a bonding press.

20. The method of claim 11, wherein bonding the jet stack comprises depositing body spacers on the membrane between the membrane and the jet stack.

21. The method of claim 20, wherein the body spacers are aligned with spacers formed in the insulator layer.
